(19) United States
(12) Patent Application Publication
(10) Pub. No.: US 2025/0208430 A1
(43) Pub. Date: Jun. 26, 2025

(54) OPTICAL MODULE WITH PROJECTION AND PHOTOGRAPHY FUNCTIONS

(71) Applicant: JADE BIRD DISPLAY (SHANGHAI) LIMITED, Shanghai (CN)

(72) Inventors: Xiaohui Zhang, Shanghai (CN); Shuai Zhang, Shanghai (CN); Huiwen Xu, Shanghai (CN); Qiming Li, Shanghai (CN)

(21) Appl. No.: 18/851,895

(22) PCT Filed: Nov. 16, 2022
(86) PCT No.: PCT/CN2022/132167

§ 371 Date: Sep. 27, 2024

(51) Int. Cl. G02B 27/28; G02B 13/16

(52) U.S. Cl. CPC G02B 27/283; G02B 13/16

(57) ABSTRACT

An optical module with projection and photography functions comprises an optical lens, a light-splitting prism, a self-luminous micro-display unit, and a photoelectric image sensing unit. The optical lens has a first end and a second end. The light-splitting prism is equipped with a first end surface coupled to the second end of the optical lens, a second end surface, and multiple side surfaces. The self-luminous micro-display unit is coupled to the second end surface and is configured to emit projection light. The photoelectric image sensing unit is coupled to one of the side surfaces and is configured to receive light to form a photographic image. The optical lens, light-splitting prism, and photoelectric image sensing unit together form a photographic light transmission path. The self-luminous micro-display unit, light-splitting prism, and optical lens form a projection light transmission path. This invention integrates the photographic and projection optical modules, thereby achieving a reduction in the volume of the optical module and providing multifunctional capabilities.

### BACKGROUND OF THE INVENTION

### 1. Field of the Invention

This invention relates to an optical module, specifically an optical module equipped with projection and photography capabilities.

### 2. Description of the Prior Art

With the advancement of micro-projection optical technology, new transformations have emerged in the form of consumer electronic products. The application of projection optics in wearable electronic products, vehicle systems, and educational electronic devices brings new advantages in terms of convenience, low power consumption, and cost. Among these, a crucial hardware device in the development of projection optics is the projection optical module. The projection optical module with projection functionality achieves its purpose through a well-designed internal optical pathway.

Please refer to FIG. 1, FIG. 1 is a schematic diagram of the structure and projection light transmission path PPL1 of a projection optical module P1 according to existing technology. As shown in FIG. 1, the projection optical module P1 includes a projection lens P11 and a projection prism P12. Positioned away from the projection lens P11, on the side of the projection prism P12, is a reflective image sensor P14, with an LED light source P13 set on the top of the projection prism P12. When in operation, the light from the LED light source P13 passes through the internal reflection within the projection prism P12 to reach the reflective image sensor P14, thereby illuminating the reflective image sensor P14 (as the display brightness of the reflective image sensor P14 is low, it requires additional lighting). Subsequently, the projected image emitted by the reflective image sensor P14 travels along the projection light transmission path PPL1 through the projection lens P11 to the external environment, thereby accomplishing the normal projection function of the projection optical module P1.

As described above, since existing projection modules do not include self-luminous micro-display units—wherein a self-luminous micro-display unit refers to a display technology that uses micro-scale self-luminous LEDs as the luminous pixel units, assembled into a high-density LED array on a driver panel with high display brightness—conventional projection modules must rely on LED illumination supplemented by reflection for image projection. This necessitates a series of supplementary lighting structures within the projection module itself, thereby increasing the product's volume. Consequently, when considering adding photographic functionality to the projection module, the presence of these supplementary lighting structures in the projection module makes it difficult to achieve a miniaturized design for both photographic and projection optical modules. In other words, the projection/photography optical modules designed based on existing projection modules are bulky and large. Therefore, providing a lightweight design for a projection/photography optical module is an important current research topic and direction.

### SUMMARY OF THE INVENTION

In light of this, one aspect of this invention is to provide an optical module with projection and photography functions to solve the issues present in existing technologies. The optical module with projection and photography functions includes an optical lens, a light-splitting prism, a self-luminous micro-display unit, and a photoelectric image sensing unit. The optical lens has a first end and a second end opposite each other. The light-splitting prism is coupled to the second end of the optical lens. The light-splitting prism has a first end surface coupled to the optical lens, a second end surface opposite the first end surface, and a plurality of side surfaces coupled to both the first and second end surfaces. The self-luminous micro-display unit is coupled to the second end surface of the light-splitting prism and is configured to emit projection light into the light-splitting prism. The photoelectric image sensing unit is coupled to one of the plurality of side surfaces of the light-splitting prism and is configured to receive light to form a photographic image. The optical lens, the light-splitting prism, and the photoelectric image sensing unit together form a photographic light transmission path. The self-luminous micro-display unit, the light-splitting prism, and the optical lens together form a projection light transmission path. The incident light from the external environment enters the optical lens through the first end, travels along the photographic light transmission path, passes through the second end, enters the first end surface of the light-splitting prism, and is reflected within the light-splitting prism to the side surface coupled to the photoelectric image sensing unit, then received by the photoelectric image sensing unit to form a photographic image. The projection light emitted by the self-luminous micro-display unit enters the light-splitting prism through the second end surface along the projection light transmission path, passes through the first end surface, enters the second end of the optical lens, and exits from the first end of the optical lens to form a projection image.

Wherein, when the self-luminous micro-display unit is coupled to the photoelectric image sensing unit, the photoelectric image sensing unit receives an image formed by the incident light and transmits the image to the self-luminous micro-display unit, then the self-luminous micro-display unit converts the image into the projection light for outputting.

Wherein, the optical lens is a LENS optical lens.

Wherein, the light-splitting prism is either a polarizing film-equipped light-splitting prism or a spectral film-equipped light-splitting prism. The polarizing film-equipped light-splitting prism allows horizontally polarized light to pass through and reflects vertically polarized light. The spectral film-equipped light-splitting prism allows light within a specific spectral range to pass through or reflect, while reflecting or transmitting light outside the specific spectral range.

Wherein, the self-luminous micro-display unit includes a display panel with a high-brightness luminescent array.

Wherein, the photoelectric image sensing unit contains a photoelectric conversion element for any wavelength band.

Wherein, the optical lens and the light-splitting prism are designed with coatings to separate and apply multiple spectra of ultraviolet light, visible light, and infrared light, or achieve specialized projection imaging within a specific spectral range through narrow-band coating.

Wherein, the optical module with projection and photography functions further includes a processor, coupled to both the self-luminous micro-display unit and the photoelectric image sensing unit, configured to process the projection light to be output by the self-luminous micro-display unit and the incident light received by the photoelectric image sensing unit.

Wherein, the optical module with projection and photography functions further includes a projection processor and a photography processor. The projection processor is coupled to the self-luminous micro-display unit, configured to process the projection light to be emitted by the self-luminous micro-display unit. The photography processor is coupled to the photoelectric image sensing unit, configured to process the incident light received by the photoelectric image sensing unit.

This invention also provides another optical module with projection and photography functions to address the problems of existing technologies. The optical module with projection and photography functions includes an optical lens, a light-splitting prism, a self-luminous micro-display unit, and a photoelectric image sensing unit. The optical lens has a first end and a second end opposite each other. The light-splitting prism is coupled to the second end of the optical lens. The light-splitting prism has a first end surface coupled to the optical lens, a second end surface opposite the first end surface, and a plurality of side surfaces coupled to both the first and second end surfaces. The self-luminous micro-display unit is coupled to one of the multiple side surfaces of the light-splitting prism and is configured to emit projection light to the light-splitting prism. The photoelectric image sensing unit is coupled to the second end surface of the light-splitting prism and is configured to receive light to form a photographic image. The optical lens, the light-splitting prism, and the photoelectric image sensing unit together form a photographic light transmission path. The self-luminous micro-display unit, the light-splitting prism, and the optical lens together form a projection light transmission path. The incident light from the external environment enters the optical lens through the first end along the photographic light transmission path, passes through the second end, enters the first end surface of the light-splitting prism, and after passing through the second end surface, is received by the photoelectric image sensing unit to form a photographic image. The projection light emitted by the self-luminous micro-display unit enters the light-splitting prism from the side surface coupled to the self-luminous micro-display unit, and is reflected within the light-splitting prism to the first end surface, passes through the first end surface, enters the second end of the optical lens, and exits from the first end of the optical lens to form a projection image.

Compared to prior art, the optical module with projection and photography functions of this invention offers the following benefits: 1. The optical module of this invention is designed with two light transmission paths within a limited space, achieving projection functionality through the design of the projection light transmission path, and photography functionality through the design of the photography light transmission path, thereby integrating both projection and photography functions into one unit. 2. The optical module of this invention utilizes a self-luminous micro-display unit, which, due to its high brightness characteristics, replaces the LED light sources and reflective image sensors found in existing technologies, thereby achieving a lightweight design.

### BRIEF DESCRIPTION OF THE APPENDED DRAWINGS

FIG. 1 is a schematic diagram of the structure and projection light transmission path of a projection optical module according to existing technology.

FIG. 2 is a schematic diagram of the structure of an optical module with projection and photography functions according to a specific embodiment of this invention.

FIG. 3 is a schematic diagram of the projection light transmission path and photography light transmission path of an optical module with projection and photography functions according to a specific embodiment of this invention.

FIG. 4 is a schematic diagram of the projection light transmission path and photography light transmission path of an optical module with projection and photography functions according to another specific embodiment of this invention.

### DETAILED DESCRIPTION OF THE INVENTION

A detailed description of the hereinafter described embodiments of the apparatus and method are presented herein by way of disclosed exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

In the various embodiments disclosed in this invention, the terminology used is for the purpose of describing specific embodiments only and is not intended to limit the disclosed embodiments. Singular forms used here also include plural forms unless the context clearly indicates otherwise. Unless defined otherwise, all terms used in this description (including technical and scientific terms) have the same meaning as commonly understood by one of ordinary skill in the art of this invention. Terms defined in a general dictionary will be interpreted to have a meaning consistent with their context in the technical field and will not be interpreted in an idealized or overly formal sense unless expressly so defined in the disclosed embodiments.

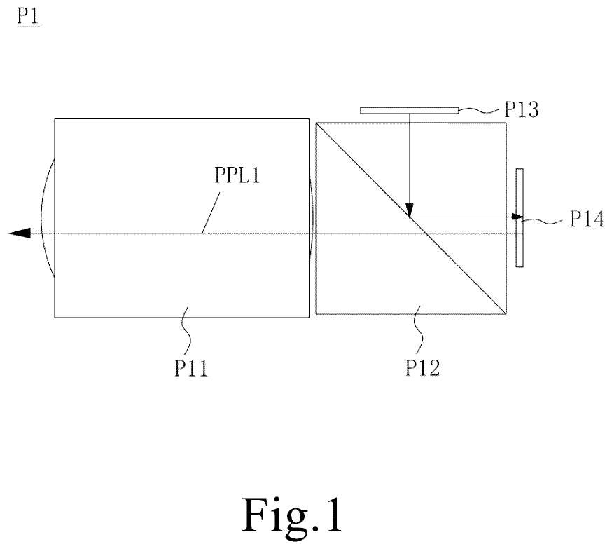

Before discussing the embodiments of the optical module with projection and photography functions of this invention, in order to better understand the technical features of this invention, an introduction to the existing projection optical modules in current technology will be provided. Please refer to FIG. 1, FIG. 1 illustrates a schematic diagram of the structure and projection light transmission path PPL1 of a projection optical module P1 according to existing technology. As shown in FIG. 1, the existing projection optical module P1 includes a projection lens P11, a projection prism P12, an LED auxiliary light source P13, and a reflective image sensor P14. The projection lens P11 is coupled to the projection prism P12, and the projection prism P12 is coupled on a side distal to the projection lens P11 to the reflective image sensor P14, with an LED auxiliary light source P13 positioned on the top of the projection prism P12. The projection lens P11, projection prism P12, LED auxiliary light source P13, and reflective image sensor P14 together form the projection light transmission path PPL1. Due to the low display brightness of the reflective image sensor P14, additional lighting is needed to achieve a sufficiently bright projection light. Therefore, the projection light transmission path PPL1 involves light emitted by the LED auxiliary light source P13, the light passes through internal reflections within the projection prism P12 to reach the reflective image sensor P14, thus providing supplementary lighting to the reflective image sensor P14. Subsequently, the projection light emitted by the reflective image sensor P14, after being augmented by the LED auxiliary light source P13, passes sequentially through the projection prism P12 and the projection lens P11, projecting the light into the external environment, thus completing the normal projection function of the projection optical module P1.

As discussed, existing projection modules rely on LED supplementary lighting on reflective image sensors for image projection, which necessitates the inclusion of a series of supplementary lighting structures within the projection optical module itself, thereby increasing its volume. Adding a photography function to such a projection optical module would be problematic as the space already occupied by the supplementary lighting components limits the ability to integrate additional photographic components, preventing the design of a compact optical module combining both projection and photography. In other words, adding photography functionality to existing projection modules would result in a bulky and large final product. Addressing this issue, providing a lightweight design for an optical module including both projection and photography functionalities is a necessary improvement that needs to be addressed.

A specific embodiment of this invention is an optical module including both projection and photography functions, consisting of an optical lens, a light-splitting prism, a self-luminous micro-display unit, and a photoelectric image sensing unit. In practical applications, the optical lens is a LENS optical lens. The light-splitting prism is either equipped with a polarizing film or a spectral film. The polarizing film-equipped light-splitting prism allows horizontally polarized light to pass through while reflecting vertically polarized light. Alternatively, the spectral film-equipped light-splitting prism allows light within specific spectral ranges to pass through or reflect, and light outside these specific ranges to reflect or pass through. The self-luminous micro-display unit includes a display panel with a high-brightness luminescent array. This micro-display unit uses self-luminous micro-scale LEDs as luminous pixel units assembled onto a driver panel to create a high-density LED array with high display brightness. The photoelectric image sensing unit contains a photoelectric conversion element capable of processing any wavelength of light.

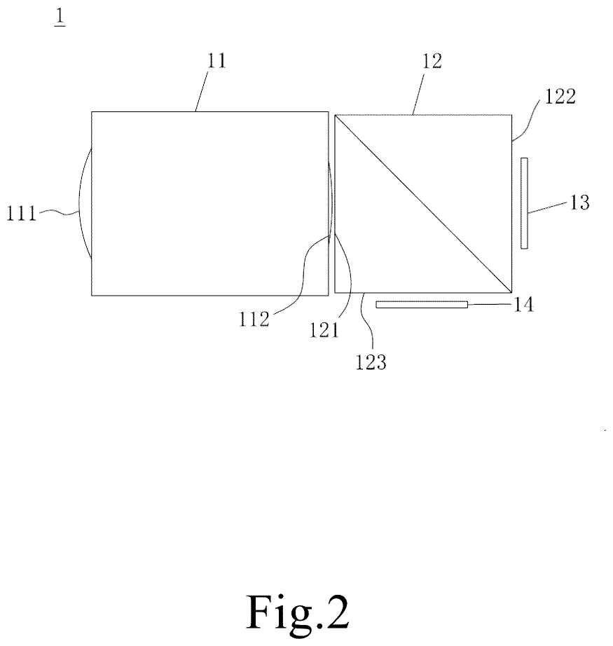

Please refer to FIG. 2, FIG. 2 shows a schematic diagram of the structure of an optical module 1 with projection and photography functions according to a specific embodiment of this invention. As depicted in FIG. 2, the optical lens 11 has opposing first end 111 and second end 112. The light-splitting prism 12 is coupled to the second end 112 of the optical lens 11. The light-splitting prism 12 has a first end face 121 coupled to the optical lens 11, a second end face 122 opposite to the first end face 121, and a plurality of side faces 123 coupled to both the first end face 121 and the second end face 122. The self-luminous micro-display unit 13 is coupled to the second end face 122 of the light-splitting prism 12, and is configured to emit projection light to the light-splitting prism 12. The photoelectric image sensing unit 14 is coupled to one of the several side faces 123 of the light-splitting prism 12 and is configured to receive light to form a photographic image.

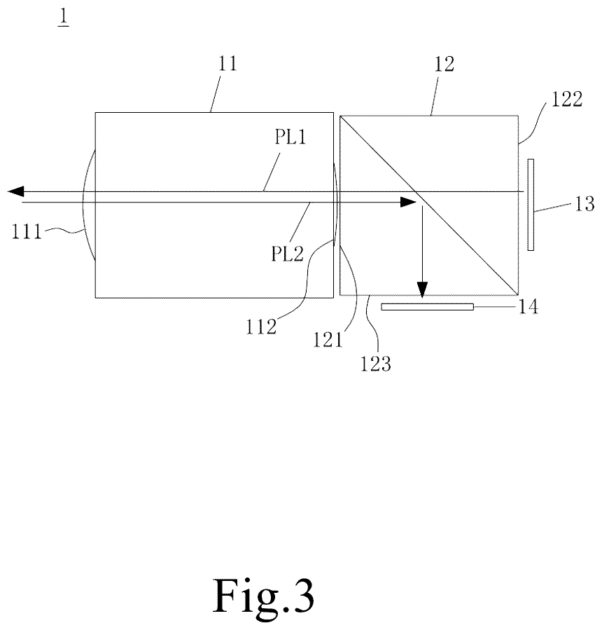

Please refer to FIG. 3, FIG. 3 illustrates the projection light transmission path and the photography light transmission path of an optical module with projection and photography functions according to a specific embodiment of this invention. As shown in FIG. 3, the self-luminous micro-display unit 13, the light-splitting prism 12, and the optical lens 11 together form the projection light transmission path PL1. The optical lens 11, the light-splitting prism 12, and the photoelectric image sensing unit 14 together form the photography light transmission path PL2. The incident light from the external environment enters through the first end 111 of the optical lens 11 along the photography light transmission path PL2, passes through the second end 112, and enters the first end face 121 of the light-splitting prism 12, then is reflected within the light-splitting prism 12 to the side face 123 coupled to the photoelectric image sensing unit 14, and is received by the photoelectric image sensing unit 14 to form a photographic image. The projection light emitted by the self-luminous micro-display unit 13 travels along the projection light transmission path PL1 from the second end face 122 of the light-splitting prism 12, passes through the first end face 121, enters the second end 112 of the optical lens 11, and exits from the first end 111 of the optical lens 11 to form a projection image.

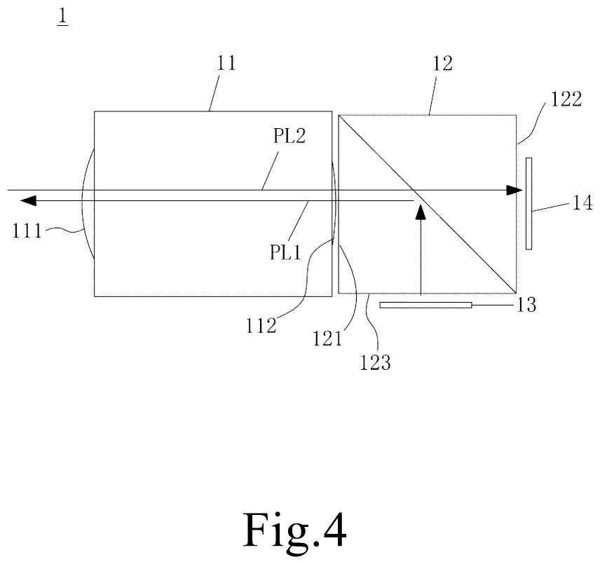

Please refer to FIG. 4, FIG. 4 illustrates the projection light transmission path PL1 and the photography light transmission path PL2 of an optical module 1 with projection and photography functions according to another specific embodiment of this invention. As shown in FIG. 4, this embodiment differs from the previous one in the placement of the self-luminous micro-display unit 13 and the photoelectric image sensing unit 14, as well as adjustments in how the light-splitting prism 12 handles the transmission and reflection of light. This optical module 1 includes an optical lens 11, a light-splitting prism 12, a self-luminous micro-display unit 13, and a photoelectric image sensing unit 14. The optical lens 11 has opposing first end 111 and second end 112. The light-splitting prism 12 is coupled to the second end 112 of the optical lens 11. The light-splitting prism 12 has a first end face 121 coupled to the optical lens 11, a second end face 122 opposite the first end face 121, and several side faces 123 coupled to both the first end face 121 and the second end face 122. The self-luminous micro-display unit 13 is coupled to one of the several side faces 123 of the light-splitting prism 12 and is configured to emit projection light to the light-splitting prism 12. The photoelectric image sensing unit 14 is coupled to the second end face 122 of the light-splitting prism 12 and is configured to receive light to form a photographic image. The optical lens 11, the light-splitting prism 12, and the photoelectric image sensing unit 14 together form the photography light transmission path PL2. The self-luminous micro-display unit 13, the light-splitting prism 12, and the optical lens 11 together form the projection light transmission path PL1. The incident light from the external environment enters through the first end 111 of the optical lens 11 along the photography light transmission path PL2, passes through the second end 112, and enters the first end face 121 of the light-splitting prism 12. After passing through the second end face 122, the incident light is received by the photoelectric image sensing unit 14 to form a photographic image. The projection light emitted by the self-luminous micro-display unit 13 travels along the projection light transmission path PL1 from the side face 123 coupled to the self-luminous micro-display unit 13, and is reflected within the light-splitting prism 12 to the first end face 121, passes through the first end face 121, enters the second end 112 of the optical lens 11, and exits from the first end 111 of the optical lens 11 to form a projection image.

It should be noted that without affecting the functionality of the photography light transmission path and the projection light transmission path, users can adjust the relative positions of the components and the conditions for light transmission and reflection of the light-splitting prism based on product design and application needs, but are not limited to this arrangement.

In practical applications, the optical lens and light-splitting prism are designed with coatings to selectively separate and utilize multiple spectra of ultraviolet, visible, and infrared light, or to achieve specialized projection imaging within a specific spectral range through narrow-band coating. This design enhances the application range of the optical module of this invention. The scope of light wave application for this optical module is not limited to the visible spectrum but can also extend to wavelengths not visible to the human eye, to meet different application scenarios. Examples include 3D printing (utilizing UV light projection), night-time operations (using infrared light in photography panoramas), facial health diagnostics, and quality inspections, among others.

In practical applications, the optical module with projection and photography functions of this invention includes at least one processor. When the optical module has only one processor, the processor is coupled to both the self-luminous micro-display unit and the photoelectric image sensing unit. The processor is used to process the projection light to be emitted by the self-luminous micro-display unit, as well as the incident light received by the photoelectric image sensing unit. When the optical module has two processors, the optical module includes both a projection processor and a photography processor. The projection processor is coupled to the self-luminous micro-display unit and is used to process the projection light to be emitted. The photography processor is coupled to the photoelectric image sensing unit and is used to process the incident light the photoelectric image sensing unit received. It should be emphasized that to ensure smooth operation of both photography and projection functionalities, users can adjust the number of processors and their coupling based on their needs, without being restricted to this configuration.

In practical applications, the self-luminous micro-display unit can be further coupled to the photoelectric image sensing unit. The photoelectric image sensing unit receives the image formed by the incident light and transmits the image to the self-luminous micro-display unit, then the self-luminous micro-display unit converts the image into projection light for output.

Compared to existing projection optical modules, the optical module of this invention enhances functionality by including a photoelectric image sensing unit and designing a photography light transmission path, achieving dual capabilities in projection and photography. In this configuration, the optical lens serves as both the projection lens and the camera lens, thus combining camera and projector modules in smart wearables or other electronic products. Additionally, since the optical module of this invention uses a self-luminous micro-display unit, therefore eliminates the need for supplementary lighting components, saving about 30-40% of space. Therefore, this invention accomplishes the goal of designing a lightweight optical module structure with projection and photography capabilities.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An optical module with projection and photography functions, comprising:
an optical lens, having a first end and a second end opposite to each other;
a light splitting prism, coupled to the second end of the optical lens, the light splitting prism having a first end surface coupled to the optical lens, a second end surface opposite to the first end surface, and a plurality of side surfaces coupled to the first and second end surfaces;
a self-luminous micro-display unit, coupled to the second end surface of the light splitting prism, wherein the self-luminous micro-display unit is configured to emit projection light towards the light splitting prism; and
a photoelectric image sensing unit, coupled to one of the side surfaces of the light splitting prism, wherein the photoelectric image sensing unit is configured to receive light to form a photographic image;
wherein, the optical lens, the light splitting prism, and the photoelectric image sensing unit form a photographic light transmission path, and the self-luminous micro-display unit, the light splitting prism, and the optical lens form a projection light transmission path; an incident light from the external environment enters the optical lens through the first end along the photographic light transmission path, passes through the second end and enters the first end surface of the light splitting prism, and is reflected within the light splitting prism to the side surface coupled to the photoelectric image sensing unit to be received by the photoelectric image sensing unit to form the photographic image;
the projection light emitted by the self-luminous micro-display unit enters the light splitting prism through the second end surface along the projection light transmission path, passes through the first end surface to the second end of the optical lens, and exits from the first end of the optical lens to form a projection image.

2. The optical module with projection and photography functions of claim 1, wherein, when the self-luminous micro-display unit is coupled to the photoelectric image sensing unit, the photoelectric image sensing unit receives an image formed by the incident light and transmits the image to the self-luminous micro-display unit, and then the self-luminous micro-display unit converts the image into the projection light for outputting.

3. The optical module with projection and photography functions of claim 1, wherein the optical lens is a LENS optical lens.

4. The optical module with projection and photography functions of claim 1, wherein the light splitting prism is a light splitting prism with a polarizing film or a light splitting prism with a spectral film; the light splitting prism with a polarizing film allows horizontally polarized light in the light to pass through and reflects vertically polarized light in the light; the light splitting prism with a spectral film allows the light with a specific spectral range to pass through or reflects the light with a specific spectral range, and reflects the light out of the specific spectral range or allows the light out of the specific spectral range to pass through.

5. The optical module with projection and photography functions of claim 1, wherein the self-luminous micro-display unit comprises a display panel with a high-brightness luminescent array.

6. The optical module with projection and photography functions of claim 1, wherein the photoelectric image sensing unit comprises a photoelectric conversion element for any wavelength band.

7. The optical module with projection and photography functions of claim 1, wherein the optical lens and the light splitting prism separates and applies the spectra multiple spectra of ultraviolet light, visible light, and infrared light by coating, or achieves special projection imaging for a specific spectral range by narrowband coating.

8. The optical module with projection and photography functions of claim 1, further comprising a processor coupled to the self-luminous micro-display unit and the photoelectric image sensing unit, wherein the processor is configured to process the projection light to be output by the self-luminous micro-display unit, as well as the incident light received by the photoelectric image sensing unit.

9. The optical module with projection and photography functions of claim 1, further comprising a projection processor coupled to the self-luminous micro-display unit and a photography processor coupled to the photoelectric image sensing unit, wherein the projection processor is configured to process the projection light to be output by the self-luminous micro-display unit, and the photography processor is configured to process the incident light received by the photoelectric image sensing unit.

10. An optical module with projection and photography functions, comprising:
an optical lens, having a first end and a second end opposite to each other;
a light splitting prism, coupled to the second end of the optical lens, the light splitting prism having a first end surface coupled to the optical lens, a second end surface opposite to the first end surface, and a plurality of side surfaces coupled to the first and the second end surfaces;
a self-luminous micro-display unit, coupled to one of the side surfaces of the light splitting prism, wherein the self-luminous micro-display unit is configured to emit projection light towards the light splitting prism; and
a photoelectric image sensing unit, coupled to the second end surface of the light splitting prism, wherein the photoelectric image sensing unit is configured to receive light to form a photographic image;
wherein, the optical lens, the light splitting prism, and the photoelectric image sensing unit form a photographic light transmission path, and the self-luminous micro-display unit, the light splitting prism, and the optical lens form a projection light transmission path; an incident light from the external environment enters the optical lens through the first end along the photographic light transmission path, passes through the second end and enters the first end surface of the light splitting prism, and then passes through the second end surface to be received by the photoelectric image sensing unit to form the photographic image; the projection light emitted by the self-luminous micro-display unit enters the light splitting prism from the side surface to the self-luminous micro-display unit is coupled, is reflected within the light splitting prism to the first end surface, passes through the first end surface to the second end of the optical lens, and exits from the first end of the optical lens to form a projection image.
